(19) United States
(12) Patent Application Publication
(10) Pub. No.: US 2025/0298929 A1
(43) Pub. Date: Sep. 25, 2025

(54) DISCRETISATION OF BUILDING MODELS TO ENABLE THE SPATIAL POSITIONING OF TECHNICAL COMPONENTS

(71) Applicant: Optimuse GmbH, Wien (AT)

(72) Inventors: Fabian Pitscheider, Wien (AT); Dominik Pezzei, Wien (AT); Felix Maximilian Hoffer, Wien (AT)

(21) Appl. No.: 18/863,676

(22) PCT Filed: May 11, 2023
(86) PCT No.: PCT/AT2023/060154

§ 371 Date: Nov. 7, 2024

(30) Foreign Application Priority Data
May 11, 2022 (AT) A 50331/2022

(51) Int. Cl. G06F 30/13

(52) U.S. Cl. CPC G06F 30/13

(57) ABSTRACT

A method for determining an optimal installation position of an electronic device in an area of a building, the electronic device being configured to monitor and/or serve the area, comprising the following steps: Providing a representation of the building, wherein the area comprises at least one building element; Generating data points arranged in a grid; Labelling each data point with a data point label, the data point label providing information if a respective data point is associated with the at least one building element and, if the data point is associated with the at least one building element, about which kind of building element the data point is associated with; Simulating placements of the at least one electronic device at valid installation positions, thereby determining a monitoring and/or serving coverage of the electronic device; and Outputting the optimal installation position with the highest monitoring and/or serving coverage.

The present invention relates to a computer implemented method for determining an optimal installation position of at least one electronic device in an area of a building, the electronic device being configured to monitor and/or serve the area.

Further, the invention relates to an apparatus for carrying out the method mentioned above, a computer program and a computer-readable storage medium.

The invention also relates to a method for installing at least one electronic device.

Electronic devices, such as fire detection sensors, are used for monitoring buildings to early detect hazardous situations and thus avoid potential major damages or injuries to persons. Once installed, fire detection sensors allow for a steady and reliable monitoring of an area or a zone in a building and require only little maintenance work. For safety reasons, it is therefore required by law in many countries to install fire detection sensors in new buildings or even in existing buildings.

Like most electronic sensors, fire detection sensors are limited in their monitoring coverage, i.e., their spatial scope of detection. Thus, usually several electronic sensors have to be installed in each story of a building to ensure adequate monitoring of the whole building. As an approximation, it can be assumed that fire detection sensors, like many other types of sensors, have a conically or semi-spherically shaped monitoring coverage. To achieve a complete monitoring of a building, the monitoring coverages of neighboring fire detection sensors should be adjacent or overlapping partially, resulting in a dense grid of sensors. In the building, obstacles, such as walls or pillars, narrow the monitoring coverage of the fire detection sensors. Therefore, construction engineers have to adequately pay attention to these obstacles in the planning phase.

Since the determination of installation positions for fire detection sensors has to follow complex rules and regulations, this planning step is rather time-consuming and labor-intensive, especially for large multistory buildings. This is aggravated by the fact that this process is mainly carried out manually by marking symbols on a paper or 2D-CAD plan (CAD=Computer-Aided Design) or by positioning objects in a BIM model (BIM=Building Information Modelling). Disadvantageously, the manual determination of installation positions leads to arbitrary, non-scalable, non-repeatable and non-reproducible results. Thus, if the plan or model of a building is revised or changed, the installation positions for the fire detection sensors have to be determined anew.

Another disadvantage is that certain obstacles, such as false ceilings, pipes, wires or projections, are not always accurately indicated or visible in the plans or BIM-models used for determining installation positions of fire detection sensors. Thus, during installation of fire detection sensors, construction workers or engineers occasionally notice that the monitoring coverage of a fire detection sensor may be further narrowed by obstacles that were not included in the 2D-plans or digital the BIM-Model. In this case, construction workers or engineers have to rearrange the fire detection sensors on site or add additional fire detection sensors, which increases the costs and takes additional time.

The above-described problems also apply to other types of electronic devices with limited monitoring coverages, such as gas detection sensors, smoke detection sensors, presence sensors or (surveillance) cameras.

Besides sensors for monitoring, buildings are also equipped with electronic devices that provide services or media, such as Wi-Fi, sound or light. Also, these types of electronic devices have limited spatial coverage, which coverage may be also referred to as serving coverage.

In the prior art, methods for positioning of electronic devices or generating wiring plans for electronic devices in buildings are known from US 2021/0073441 A1, WO 2015/132691 A2 or US 2018/0121571 A1. However, these methods do not adequately take into account obstacles such as false ceilings, pipes, wires or other projections. Therefore, the installations positions outputted in the prior art cannot be considered optimal in any case and, as described above, construction workers or engineers occasionally have to rearrange electronic devices during installation occasionally.

In the light of the above, it is an objective of the present invention to eliminate or alleviate the disadvantages of the prior art. Preferably, it is an objective of the present invention to provide a computer-implemented method by means of which it is possible to automatically determine an optimal installation position for an electronic device in an area of a building whilst taking into account all potential obstacles of the building in the vicinity of the installation position that might narrow the monitoring and/or serving coverage of the electronic device.

The computer-implemented according to claim 1, the method for installing at least one electronic device in a building according to claim 16, the data-processing apparatus according to claim 17, the computer program product according to claim 18 and the computer-readable storage medium according to claim 19 solve this objective.

The inventive computer implemented method for determining an optimal installation position of at least one electronic device in an area of a building comprises the following steps:
i) Providing a representation, preferably a model, of the building including the area, wherein the area comprises at least one building element, preferably one or more of the following: a wall, a ceiling, a floor and a pillar;
ii) Generating data points arranged in a grid in a three-dimensional coordinate system, the data points representing the area with the at least one building element;
iii) Labelling each data point with a data point label, the data point label providing information if a respective data point is associated with the at least one building element and, if the data point is associated with the at least one building element, about which kind of building element the data point is associated with;
iv) Simulating placements of the electronic device at valid installation positions within the area, thereby determining a preferably weighted monitoring and/or serving coverage of the electronic device for each simulated valid installation position, preferably by means of raytracing, the monitoring and/or serving coverages covering data points with a certain data point label depending on a type of the electronic device; and v) Outputting the optimal installation position of the electronic device with the highest monitoring and/or serving coverage.

Since the inventive method uses data points in a three-dimensional coordinate system representing an area of the building, obstacles such as false ceilings, pipes or other projections of the building can be taken into account when determining installation positions for an electronic device. In this way, the risk of rearrangements of electronic devices during the installation of electronic devices can be reduced or even avoided. In the present disclosure, an area denotes a part, i.e. a section, region or space, of a building and is not restricted to the 2D-space. In the prior art, construction engineers typically use top view plans (2D-plans) of the buildings for determining installation positions for the electronic devices, which top view plans usually do not include pipes, wires and false ceilings or other projections that may narrow a monitoring and/or serving coverage. The representation of the building used by the inventive method may be a model, in particular a BIM model (BIM=Building Information Modelling), which comprises all kinds of plan layers, such as layers for wiring, water pipes and building elements such as walls, floors and ceilings. As file formats, proprietary file formats such as RVT or open standard file formats such as IFC may be used. Alternatively, also a 3D-scan of a building may serve as representation of the building. The representation may be saved in a memory, which may be located in a computer or a server. In step ii), data points are derived from the representation. The data points may be saved as three-dimensional coordinates. The data points represent the area of the building in which the at least one electronic device shall be placed. The data points are arranged in a grid. The data points form the cells of the grid. Thus, the data points have a certain spatial extension. The grid may be irregular. However, preferably, the grid is regular, hence the data points being equidistant. A regular grid with a known edge length is advantageous with regard to memory storage, because the positions of the data points in the coordinate system can be derived from their position in the grid.

Advantageously, the grid renders the present method independent from the input file format of the representation. Generating data points arranged in a grid may also be referred to as discretization. In step iii), each data point is labelled with a data point label. A data point label contains information whether a respective data point belongs to a building element, such as a wall or a ceiling, and, if this is the case, which kind of building element the data point is associated with. Thus, all data points that originate from a certain building element may be labelled as such. Data points that do not originate from a building element may be labelled as “air” or “void”. For example, such data points within a building or the area may be labelled as “air”. Data points outside the building or outside the area may be labelled as “void”. In step iv), a simulation of the placement of the electronic device at valid installation positions takes place. A valid installation position is a technically feasible installation position at which the electronic device may be installed without violating legal or technical regulations. A valid installation position may thus depend on the type of the electronic device. For example, fire detection sensors may, in most situations (except, for example, elevator shafts), only be placed on the underside of a ceiling. Loud speakers or cameras may also be placed on walls at a predetermined height. A user may also further restrict the number of valid installation positions, if desired. For example, installation positions on walls may be marked as invalid due to certain design rules. As a result of the simulation of the placement of the electronic device at a valid installation position, the monitoring and/or serving coverage of the electronic device is determined. A monitoring coverage is a region that may be monitored by an electronic device.

Preferably, the term “monitoring” comprises the acquisition of environmental data, e.g., molecules, temperature or light etc. A serving coverage is a region that may be served by an electronic device with a medium or a service, e.g., with Wi-Fi, light or sound. Approximately, in most cases, an unrestricted monitoring and/or an unrestricted serving coverage of an electronic device can be assumed to be conically or (semi-) spherically shaped (in a 3D-space) or circular (in a 2D-space), with the electronic device being located in the centre. Of course, also cuboidal, rectangular, elliptical or any other form of monitoring and/or serving coverages are conceivable. The exact size and form of an unrestricted monitoring and/or serving coverage depend on the specific type of the electronic device. However, building elements such as walls and pillars, typically narrow the monitoring and/or serving coverage of an electronic device. For example, an unrestricted, conically shaped coverage may be deformed by the presence of a pillar. The area behind the pillar may not be covered by the electronic device. During simulation, monitoring and/or serving coverages of the at least one electronic device are determined. A monitoring and/or serving coverage covers, i.e., comprises, data points with a certain data point label, such as “floor”, “wall” and/or “air”. Of course, certain data point labels may also be all data point labels used by the method. The monitoring and/or serving coverage may be determined by means of raytracing. By way of simulation, the at least one electronic device is placed at different valid installation positions and thus several monitoring and/or serving coverages are determined, thereby considering obstacles such as walls, pillars, pipes, false ceilings etc., The simulated placement of the at least one electronic device at installation positions is carried out automatically. The determined monitoring and/or serving coverages may be compared to each other. In step v), the method outputs the optimal installation position for the at least one electronic device. The optimal installation position is a position at which the at least one electronic device has the highest monitoring and/or serving coverage in comparison to the other simulated monitoring and/or serving coverages. The highest monitoring and/or serving coverage may be the coverage with the most data points, i.e. highest sum of data points covered, covered, i.e., with the largest space covered. If the installation positions or the data points are weighted (see below), the monitoring and/or serving coverage with the highest weighted sum of weighted data points may be the highest monitoring and/or serving coverage. If the optimal installation positions of several electronic devices of the same type are determined, monitoring and/or serving coverages of the other electronic devices of the several electronic devices are taken into account for each electronic device. In this way, installation positions for several electronic devices may be determined to cover an area of a building. The monitoring and/or serving coverages of several electronic devices may be adjacent or partly overlapping. Overlapping of monitoring and/or serving coverages may be limited to a certain percentage in order to avoid multiple monitoring of areas. Preferably, the steps i)-v) are carried out in the given sequence.

In a preferred embodiment, the at least one electronic device is one of the following:
a sensor, in particular a fire detection sensor, a smoke detection sensor, a gas detection sensor or a presence detection sensor,
an acoustic speaker,
a camera,
a luminaire,
an antenna,
a communication device or
a wireless-device, in particular a Wi-Fi-Router or a beacon.

Sensors and cameras are electronic devices that monitor their surroundings and thus have monitoring coverages. Acoustic speakers and luminaires provide their surroundings with medias and services within a limited range and thus have serving coverages. Antennas, communication devices and wireless-devices may have either a monitoring coverage and a serving coverage or both, depending on the type of the electronic device.

In order to keep the number of simulations of the electronic device at valid installation positions as low as possible, the placements of the at least one electronic device may be selected by an optimization algorithm in step iv), wherein the optimization algorithm takes into account the monitoring and/or serving coverages. The optimization algorithm may also take into account the distance to building elements, such as walls. In general, optimization algorithms are designed to find a maximum or a minimum of a function. The optimization algorithm may be a nondominated sorting generic algorithm (NSGA2)-algorithm. In each cycle, the optimization algorithm selects a valid installation position for the at least one electronic device with a high chance of having a higher preferably weighted monitoring and/or serving coverage than the previous installation positions. Thereby, the optimization algorithm takes into account the results of the previous simulations of the at least one electronic device at valid installation positions.

Since it is very difficult or in many cases even impossible to define analytical optimization problems from geometrical information (information regarding the derivative of the objective function f is hard to obtain due to the complexity of a 3D geometry), it is advantageous when the optimization algorithm is a derivative-free optimization algorithm, preferably a NSGA2-algorithm.

In a preferred embodiment, the valid installation positions and/or the data points are weighted with a preference rank prior to step iv) and the monitoring and/or serving coverages are weighted. By way of weighting the valid installation positions and/or data points, it is possible to influence the optimal installation position. In order to find the highest monitoring and/or serving coverage and hence the optimal installation position, the sum of weighted data points of each monitoring and/or serving coverage may be compared to each other. Also, monitoring and/or serving coverages may be weighted as a whole by the preference ranks of the respective valid installation positions. The preference rank may be a real number, e.g. between 0 and 10 or between 0 and 1. A weighted monitoring and/or serving coverage may therefore be higher or lower in comparison to an unweighted monitoring and/or serving coverage. In an exemplary embodiment, data points in the middle of a room may be weighted with a higher preference rank in comparison to other data points so that weighted monitoring and/or serving coverages covering these data points are higher. As a consequence, the installation positions in the middle of a room may have a higher chance to become the optimal installation position. In this way, it can be avoided that optimal installation positions are located close to edges or walls. Thus, weighted data points are a design tool that enable a user to influence the outcome of the inventive method.

In one embodiment, the weighting of the data points is based on existing or planned installation paths and/or technical guidelines. In this way it is possible, the locate the optimal installation positions of the electronic devices in proximity to already existing or planned installation paths. Thereby, the expense of additional installations and wirings can be reduced. In technical guidelines, some positions for electronic devices may be considered favourable. In one embodiment, weighted installation positions and/or weighted data points may be used to influence the optimal installation positions when multiple electronic devices are to be placed within an area. For example, electronic devices may span two preferably orthogonal axes, along which the valid installation positions for other electronic devices and/or data points may be ranked with a higher preference rank. In this way, electronic devices may have a higher chance to be placed along straight lines, hence reducing the installation work and improving optical appearance. Along these axes, installation paths for wires etc. may be arranged at a later stage.

Due to the fact that some types of electronic devices may only be installed at certain positions, the valid installation positions may depend on the type of the at least one electronic device. Some types of electronic devices may only be installed at certain positions. For example, fire detection sensors may only be installed on ceilings with a certain distance to surrounding walls or pillars. Some types of cameras may only be mounted on walls up to a certain height. Advantageously, the computational time can be significantly reduced when invalid installation positions are sorted out prior to step iv) of the inventive method.

In order to reduce the computational time of the inventive method, it is favorable if valid and invalid installation positions are defined prior to step iv).

To save memory and computational time, it is favorable if the cells of the grid are cuboid and/or the grid is regular. The cells of the grid preferably have the form of a cube. The cells are formed by the data points. Preferably, all cells of the grid are identical with regard to their size. The envelope of the grid may also be a cuboid. If the grid is regular, all the vertical and/or horizontal edges of each cell of the grid have the same length.

In a preferred embodiment, prior to step ii) a bounding box may be fitted to the area, wherein the bounding box serves as a basis for the grid. The grid may subdivide the bounding box. The bounding box may be the envelope of the grid. However, in some embodiments, the size of the cells of the grid may be predefined. Thus, in some cases the length of the bounding box may not be a multiple of the length of a cell. In such cases, cells of the grid may extend the bounding box in order to avoid cut-offs of the cells. Also in this case, the grid is considered as subdividing the bounding box.

To avoid that straight building elements obliquely cross cells of the grid, it is advantageous if the bounding box is aligned with the at least one building element of the area.

In order to save computational time and memory, it is favorable if the bounding box and the area contained therein is moved to the origin of the three-dimensional coordinate system by means of a translation and/or aligned with the axes of the three-dimensional coordinate system by means of rotation. Since the grid is moved to the origin, positions of data points may be referred to the origin of the coordinate system. When the edges of the grid are aligned with the axes of the coordinate system, the position of data points can be easily determined.

The area of the building may be a room or a part of a room of the building. Areas may be defined in the representation. BIM-models may provide areas to which the present method may be directly applied.

The area of a building in which the at least one electronic device shall be placed may be manually selected by a user. In another embodiment the area may be defined by means of a computational segmentation algorithm applied to the representation of the building. Segmentation algorithms are widely known in the prior art. Advantageously, segmentation algorithms may define areas that perfectly fit for the inventive method. Additionally, the process can be widely automated when segmentation algorithms are used.

Typically, several electronic devices of the same type are used to monitor or serve an area of a building. Advantageously, the method can be used to determine optimal installation positions of multiple electronic devices. In this preferred embodiment, in step iv) placements of the multiple electronic devices at valid installation positions are simulated and wherein in step v) optimal installation positions for each of the multiple electronic devices are outputted; and
in step iv) monitoring and/or serving coverages of the others of the multiple electronic devices are considered for each of the multiple electronic devices for determining the optimal installation positions. By considering the monitoring and/or serving coverages of the other electronic devices, a full coverage of the area can be achieved. The monitoring and/or serving coverages may be adjacent or partly overlapping.

The invention also relates to a method for installing at least one electronic device in a building, comprising the following steps:
Determining an optimal installation position for the at least one electronic device by means of the method described above; and
Installing the at least one electronic device at the optimal installation position.

A construction worker may install the at least one electronic device on site at the optimal installation position determined by the inventive method for determining an optimal installation position of at least one electronic device. The at least one electronic device may be installed with a tool. Of course, if the method determines several optimal installation positions for several electronic devices, the several electronic devices can be installed by the construction worker at their respective optimal installation position.

The invention also relates to a data processing apparatus comprising means for carrying out the method for determining an optimal installation position of at least one electronic device in an area of a building described above.

The invention also relates to a computer program product comprising instructions which, when the program is executed by a computer, cause the computer to carry out the method for determining an optimal installation position of at least one electronic device in an area of a building described above.

The invention also relates to a computer-readable storage medium comprising instructions which, when executed by a computer, cause the computer to carry out the method for determining an optimal installation position of at least one electronic device in an area of a building described above.

In the following, the invention is described by means of drawings, which the invention shall not be restricted to.

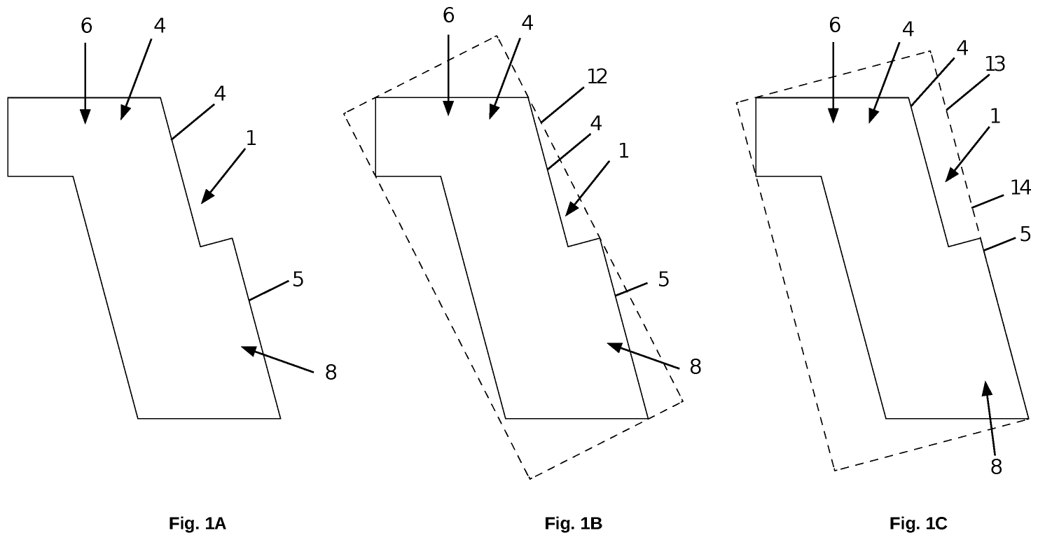

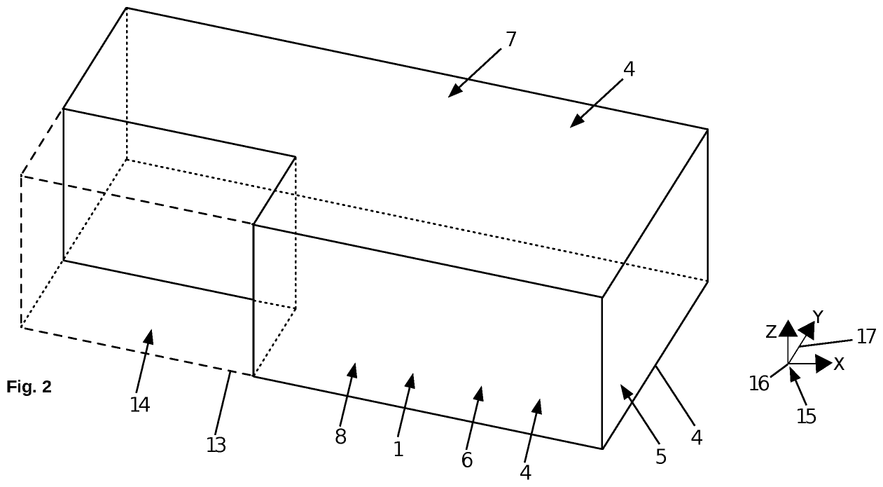

FIG. 1A-C show an area of a building being surrounded by a bounding box in a top view;

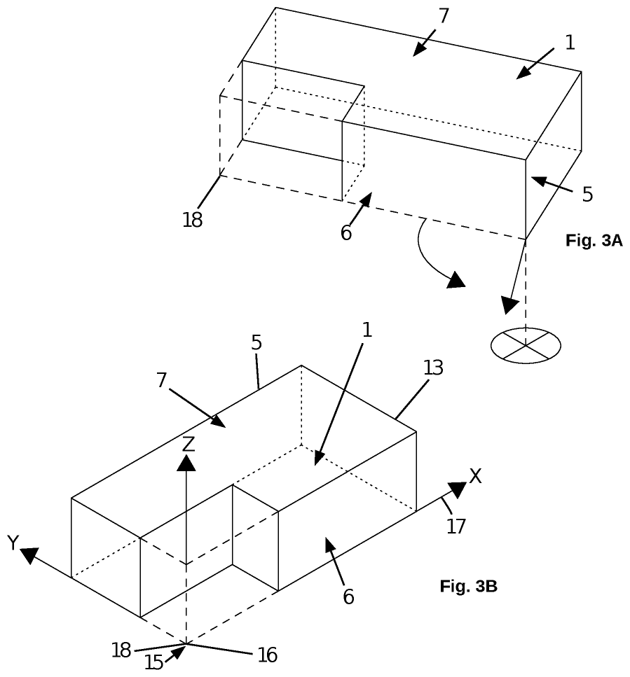

FIG. 2 shows an area of a building surrounded by an oriented bounding box in an angular view;

FIG. 3A-B show a translation and a rotation of the area within the bounding box to an origin of a coordinate system;

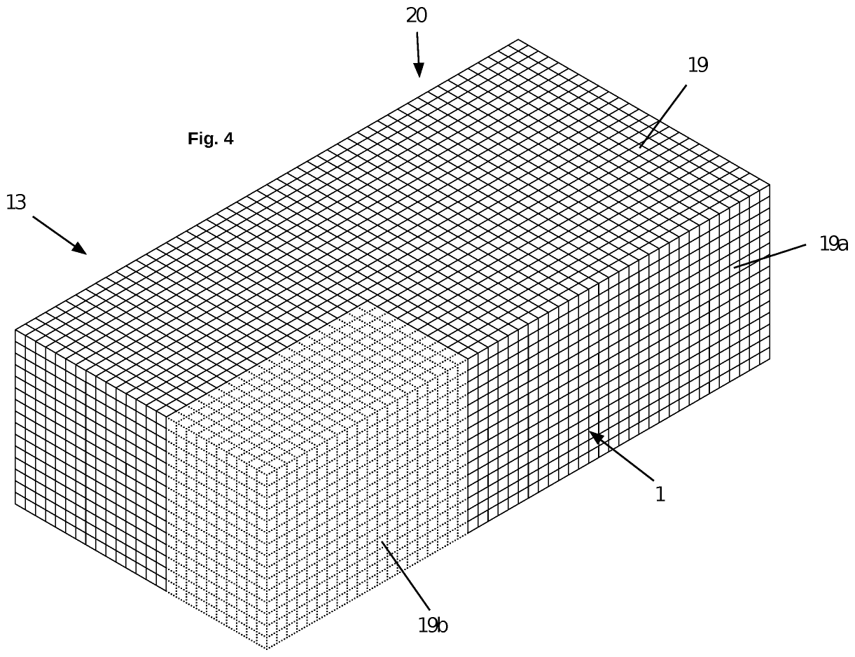

FIG. 4 shows a bounding box filled with data points;

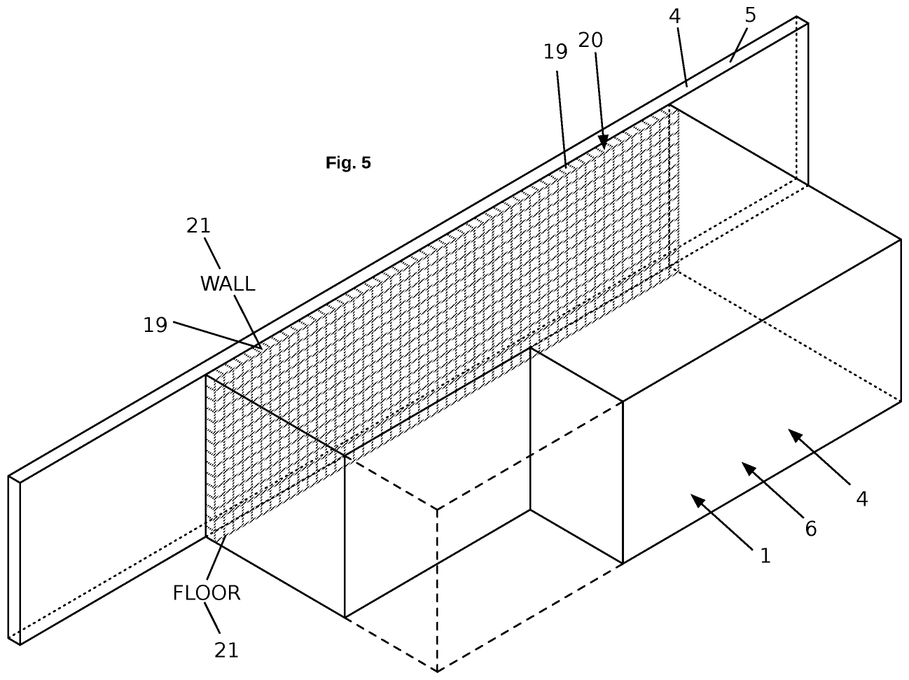

FIG. 5 shows the labelling of data points;

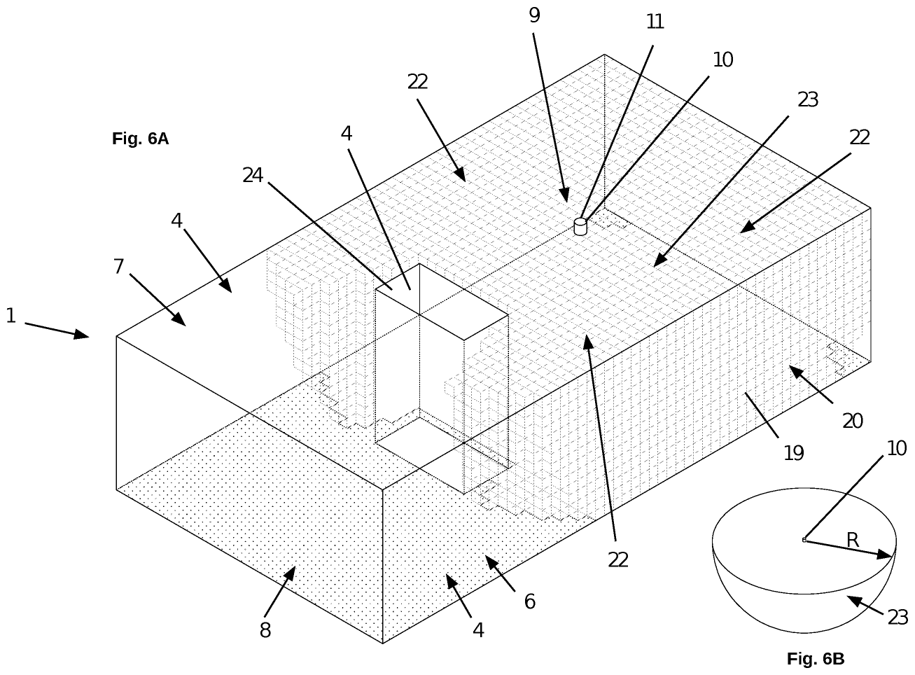

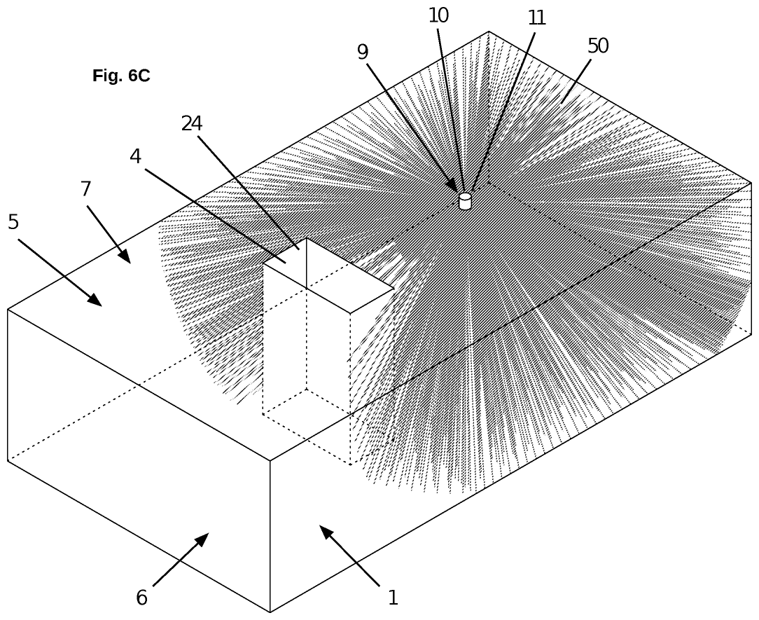

FIG. 6A shows a simulation of a monitoring and/or serving coverage;

FIG. 6B shows an unrestricted monitoring and/or serving coverage;

FIG. 6C shows the embodiment of FIG. 6A, wherein the monitoring and/or serving coverage is determined by means of ray tracing;

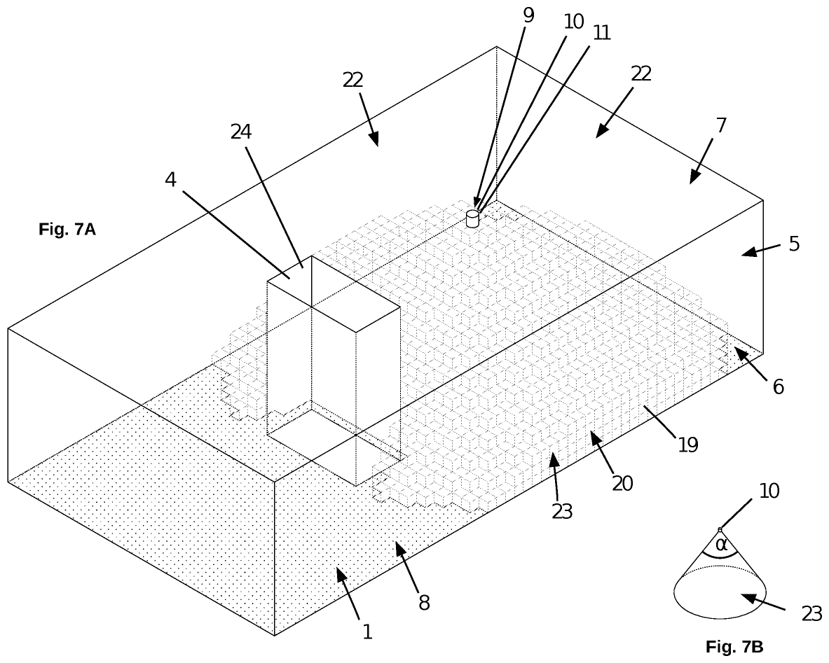

FIG. 7A shows another embodiment of a simulation of a monitoring and/or serving coverage;

FIG. 7B shows another embodiment of an unrestricted monitoring and/or serving coverage;

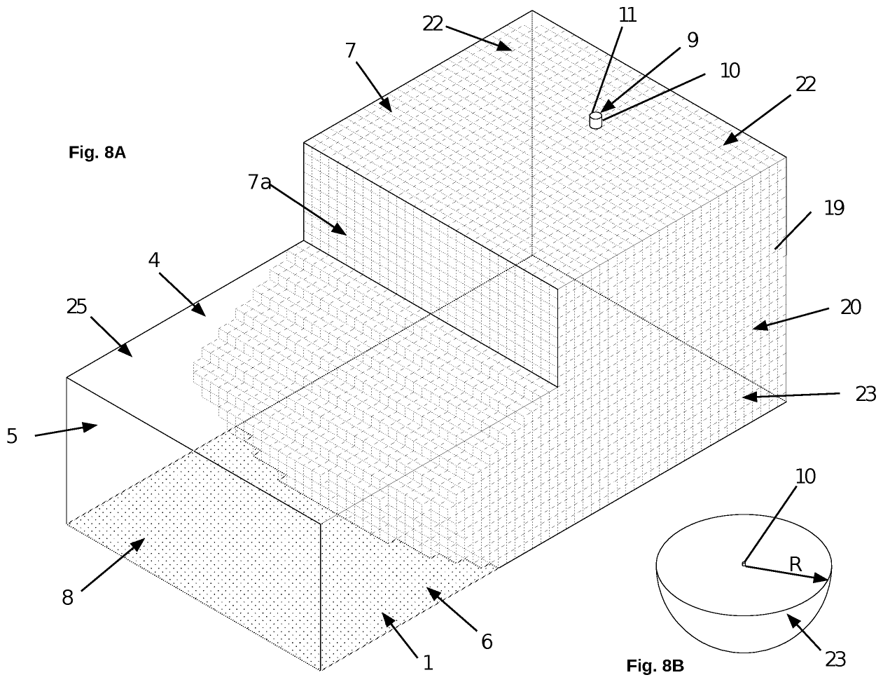

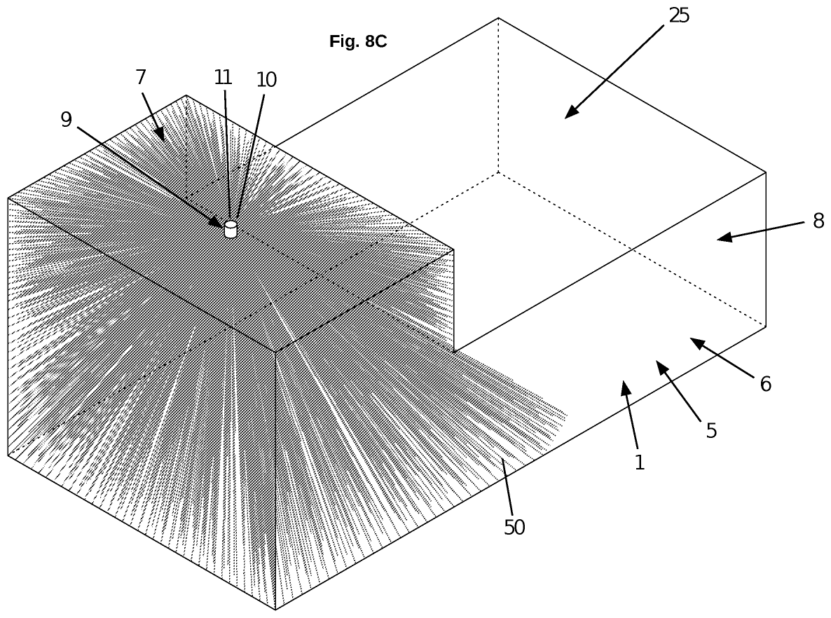

FIG. 8A shows another embodiment of a simulation of a monitoring and/or serving coverage;

FIG. 8B shows another embodiment of an unrestricted monitoring and/or serving coverage;

FIG. 8C shows the embodiment of FIG. 8A from another view, wherein the monitoring and/or serving coverage is determined by means of ray tracing;

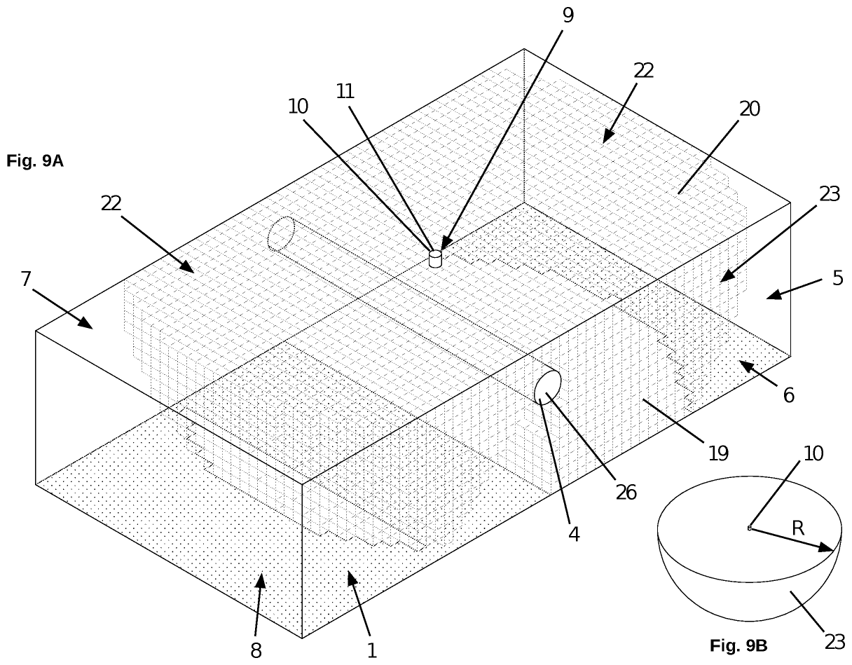

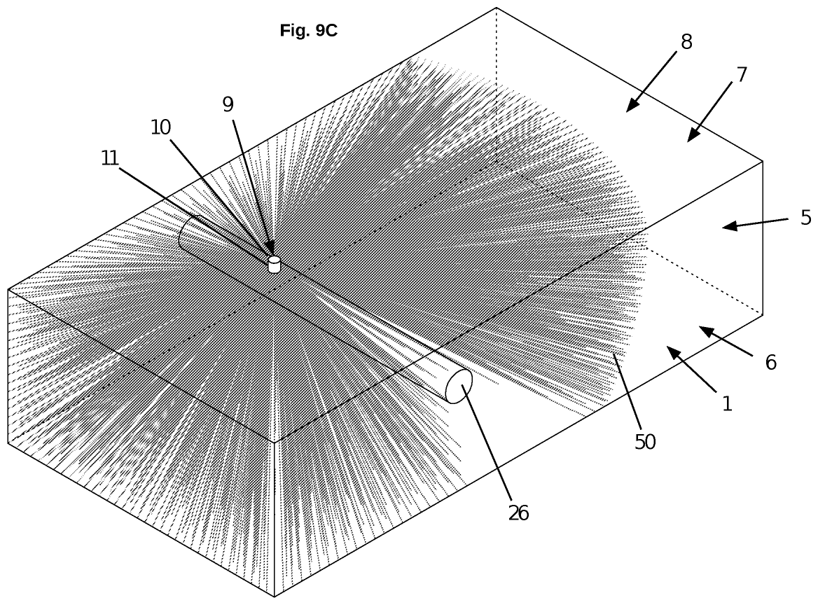

FIG. 9A shows another embodiment of a simulation of a monitoring and/or serving coverage;

FIG. 9B shows another embodiment of an unrestricted monitoring and/or serving coverage;

FIG. 9C shows the embodiment of FIG. 8A from another view, wherein the monitoring and/or serving coverage is determined by means of ray tracing;

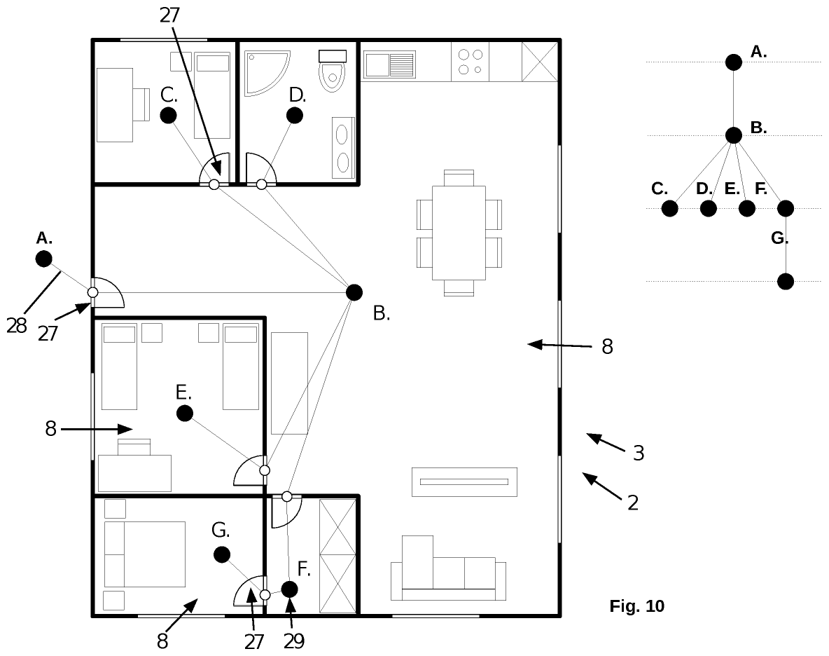

FIG. 10 shows a flat in a top view; and

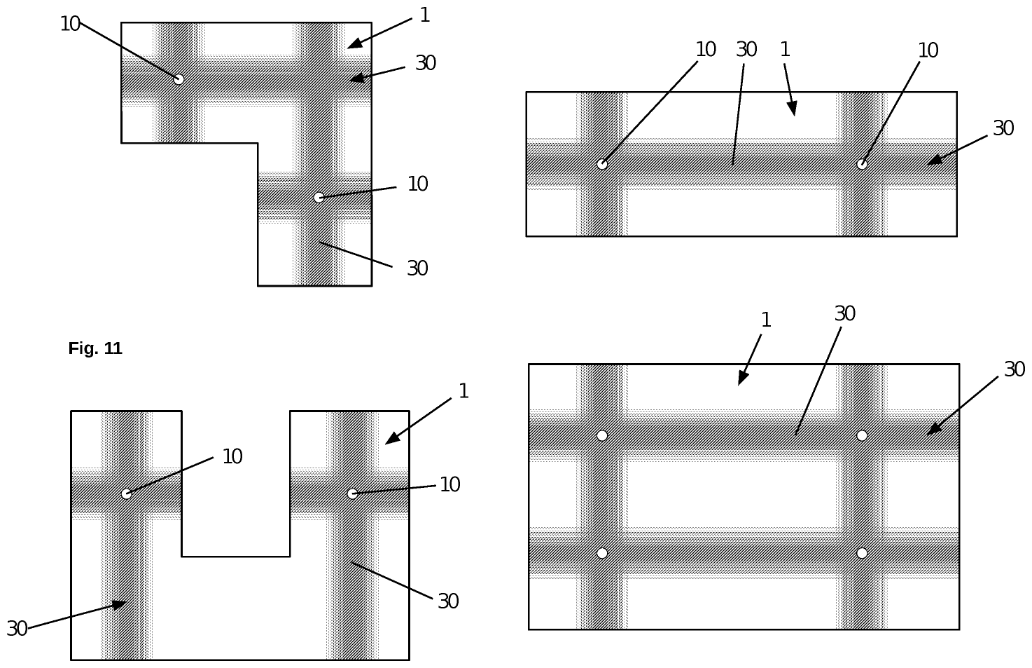

FIG. 11 shows a top view of four different areas of a building.

FIG. 1A schematically shows an area 1 of a building 2 (see FIG. 10) in a top view. The area 1 is part of a representation 3 of the building 2 and surrounded by building elements 4 such as walls 5, a floor 6 and a ceiling 7 (cf. FIG. 2). The representation 3 may be a model, in particular a BIM-model. The area 1 is part of the building 2, which may be a house. In the embodiment shown, the area 1 is a room 8.

It is an objective of the present invention to determine optimal installation positions 9 for electronic devices 10 such as fire detection sensors 11 (see FIG. 6A), acoustic loudspeakers or cameras. A preferred embodiment of the invention is described in the following.

In a first step i) the representation 3, which may be saved for example in a memory of a computer or a server (not shown), is provided. The representation 3 may be saved in a IFC or RVT file, for example. By means of a segmentation algorithm or by manual selection, the area 1 is selected and separated from the rest of the representation 3. As already mentioned, area 1 may be a room 8 or a part of a room, also referred to as “sub-room”. The invention is not restricted to rooms or sub-rooms.

After selecting an area 1, a bounding box 12 is fitted to the area 1, as depicted in FIG. 1B in top view. The bounding box 12 has generally a cuboid form and encompasses the area 1 in the narrowest possible way. However, the bounding box 12 in FIG. 1B is not aligned with any of the walls 5. As this may have unfavorable effects for the present method, it is preferred for the present method to use aligned bounding boxes 13.

FIG. 1C shows an aligned bounding box 13 which is aligned with one of the walls 5, so that the respective wall 5 is parallel to one of the side-faces 14 of the aligned bounding box 13. It is not necessary that all walls 5 are parallel with the side-faces 14 of the aligned bounding box 13.

FIG. 2 shows an area 1 of a building 2 encompassed by an aligned bounding box 13 in an angular view in a three-dimensional coordinate system 15. In the embodiment shown, all side-faces 14 of the aligned bounding box 13 are parallel with the walls 5 of the area 1.

When an area 1 of a building 2 is selected, the area 1 is usually not located at the origin 16 of the coordinate system 15 (FIG. 3A). Further, in most cases the area 1 is not aligned with the axes 17 of the coordinate system 15. However, the area 1 encompassed by the aligned bounding box 13 may be shifted to the origin 16 of the coordinate system 15 and rotated so that the side-faces 14 of the aligned bounding box 13 are oriented parallel to the axes 17 of the coordinate system 15 (FIG. 3B). The distance which the bounding box 13 is shifted and the angle of rotation may be stored in a translation vector and a rotation matrix. Preferably, a corner 18 of the aligned bounding box 13 coincides with the origin 16 of the coordinate system 15 after shifting and rotating. In this way, faster computation can be achieved.

In step ii), the aligned bounding box 13 is filled with data points 19, which may also be referred to as voxels. The data points 19 are arranged in a preferably regular grid 20. The grid 20 and the data points 19, respectively subdivide the aligned bounding box 13 entirely, as can be seen in FIG. 4. Each data point 19 may be referenced by its position within the grid 20. Each data point 19, which may be also referred to as a cell of the grid 20, may cover a spatial length and height between 50 and 500 mm, dependent from the area's size. The data points 19 are adjacent to each other. When the grid 20 is regular, each data point 19 can be easily referenced by its number or location within the grid 20. It is not required to store coordinates for each data point 19. Advantageously, by means of the grid 20, the method becomes independent of the file format of the representation 3.

In step iv), the data points 19 are labelled with data point labels 21. The data point labels 21 provide information about the type of a respective data point 19. In particular, the data point label 21 provides information if a respective data point 19 is associated with a building element 4 and, if this is the case, about which kind of building element 4 the data point 19 is associated with. Data points 19 may be associated with a building element 4 if they are part of the building element 4 or adjacent to it. Data points 19 may be for example labelled as being part or adjacent to a wall 5, a floor 6, a ceiling 7, a window, a door, a pipe or any other building element 4. Data points 19 which are not part of or are not located adjacent to a building element 4 may be labelled as void or air. Of course, data point labels 21 may also contain additional information about data points 19. In FIG. 4, the dark data points 19a are labelled as being part of the area 1. The bright data points 19b are labelled as being outside the area 1.

In FIG. 5, data points 19 that are located within or adjacent to the wall 5 are labelled as “wall”. In the same way, data points 19 located within or adjacent to any other building element 4, such as another wall 5, a floor 6, a ceiling 7 or a pillar (see FIG. 6A), may be labelled as such. Data points 19 which are not located within or adjacent to a building element 4 may be labelled as void or air.

In step iv), placements of at least one electronic device 10 at several valid installation positions 22 within the area 1 are simulated, as can be seen in FIG. 6A. Thereby, for each placement of an electronic device 10 at a valid installation position 22, a monitoring and/or serving coverage 23 of the at least one electronic device 10 is determined. The monitoring and/or serving coverage 23 represents the spatial coverage of an electronic device 10 within which it is capable of monitoring its surroundings or within which it is capable of providing (serving) its surroundings with a service or a medium. In some embodiments, a monitoring and/or serving coverage 23 may only cover data points 19 with a specific data point label 21, depending on a type of the electronic device 10.

In FIG. 6A, the placement of a fire detection sensor 11 is simulated at one of the valid installation positions 22 in the area 1. It depends on the type of electronic device 10 whether an installation position can be marked as valid or invalid. Typically, fire detection sensors are mounted on ceilings 7 of rooms 8. Thereby, legal regulations, such as minimal distances to other building elements 4, have to be considered. Thus, in the embodiment shown, each installation position on the ceiling 7 with a minimal distance of at least 500 mm (e.g., dictated by the regulation) to the walls 5 are considered as valid installation position 22 for a fire detection sensor 11.

The exact form of the monitoring and/or serving coverage 23 depends on the specific type of electronic sensor 10. With regard to a fire detection sensor 11 it can be approximately assumed that, in an empty space, its monitoring coverage 23 has a semi-spherical form with a certain radius R. This form is depicted in FIG. 6B. However, in buildings 2 the monitoring coverage 23 is usually restricted by building elements 4, such as walls 5 or pillars 24, which are obstacles for the monitoring coverage 23.

The assumption that in principle a fire detection sensor 11 has a semi-spherical monitoring coverage 23 may be applied to the area 1 of FIG. 6A. The area 1 in FIG. 6A comprises a pillar 24 located in the center, which, besides the walls 5, poses an obstacle for the monitoring and/or serving coverage 23 of the electronic device 10. It can be seen in FIG. 6A that due to the obstacles, the monitoring coverage 23 of the fire detection sensor 11 differs from the semi-spherical form shown in FIG. 6B. The actual monitoring coverage 23 can be determined, for example, by means of ray tracing. This is shown in FIG. 8C, where each ray 50 leads from the electronic device 10 to a datapoint 19. In FIG. 6A, only data points 23 that are covered by the monitoring coverage 23 are shown for the purpose of a better over-view.

In order to determine an optimal installation position 9, multiple placements of the electronic device 10 at valid installation positions 22 are simulated one after another or at the same time and their respective monitoring and/or serving coverages 23 are determined. Preferably, a derivative-free optimization algorithm that takes into account the previously determined monitoring and/or serving coverages 23 selects the valid installation positions 22 at which the placements of the electronic device 10 shall be simulated. In order to find the optimal installation position 9 for the electronic device 10, the determined monitoring and/or serving coverages 23 are compared to each other. The valid installation position 22 with the highest monitoring and/or serving coverage 23 may be outputted in step v) as the optimal installation position 9 for an electronic device 10. The highest monitoring and/or serving coverage 23 may be the monitoring and/or serving coverage 23 with the most data points 19 or the highest sum of weighted data points 19.

In one embodiment, the monitoring and/or serving coverages 23 can be influenced by weighting the valid installation positions 22 and/or by weighting the data points 19 with a preference rank (not visible). By weighting the data points 23 or the valid installation positions 22, also the related monitoring and/or serving coverages 23 can be weighted. For example, monitoring and/or serving coverages 23 which encompass data points 19 with a higher preference rank are ranked higher in comparison to monitoring and/or serving coverages 23 which encompass data points 19 with a lower preference rank. On the other hand, monitoring and/or serving coverages 23 related to valid installation positions 22 with a higher preference rank are higher in comparison to monitoring and/or serving coverages 23 related to a valid installation position with a lower preference rank. In this way, preferred design choices defined by a user can be considered by the inventive method. E.g., data points 19 in the middle of an area 1 can be assigned a higher preference rank than data points 19 at the border of the area 1, which leads to a higher chance of optimal installation positions 9 to be also located in the middle of the area 1. In order to determine the highest monitoring and/or serving coverage 23, the sums of weighted data points 19 of each simulated monitoring and/or serving coverage 23 may be compared. The monitoring and/or serving coverages 23 may also be weighted by a preference ranks of the respective valid installation position 22. A preference rank may be a real number, for example between 1 and 10.

In FIG. 6A, the placement of only one single electronic device 10 at a valid installation position is shown. According to a preferred embodiment of the invention, also multiple optimal installation positions 9 for multiple electronic devices 10 of the same type can be determined and outputted. In this embodiment, when determining an optimal installation position 9 for an electronic device 10, the monitoring and/or serving coverages 23 of the other electronic devices 10 are also taken into account. Preferably, the monitoring and/or serving coverages 23 of the electronic devices 10 when installed at their respective optimal installation positions 9 are adjacent or partially overlapping, but only according to a predefined maximum percentage. When the monitoring and/or serving coverages 23 are adjacent or even partially overlapping, a gapless monitoring and/or serving of an area 1 can be achieved. When installed, the multiple electronic devices therefore cover and/or serve the essentially entire area 1.

FIG. 7A and FIG. 7B show another embodiment of the invention. In the following, only the differences to FIG. 6A and FIG. 6B will be described. As can be seen in FIG. 7B, the unrestricted monitoring and/or serving coverage 23 is assumed to be conically shaped instead of semi-spherically shaped. The cone has an opening angle α of for example 20°-70° and is rotationally symmetrical. FIG. 7A shows a simulation of an electronic device 10 having such an unrestricted monitoring and/or serving coverage 23. Again, in FIG. 7A only data points 19 that are part of the monitoring and/or serving coverage 23 are depicted.

FIG. 8A and FIG. 8B show another embodiment of the invention. In the following, only the differences to FIG. 6A and FIG. 6B will be described. As can be seen in FIG. 8B, the shape of unrestricted monitoring and/or serving coverage 23 is also semi-spherically shaped. However, the area 1 in FIG. 8A differs significantly from the area 1 in FIG. 6A. As can be seen in FIG. 8A, the area 1 comprises a stepped ceiling 7a, wherein the lower part of the ceiling may also be referred to as false ceiling 25. In the prior art, this kind of area 1 is very difficult to handle because such false ceilings 25 are usually not or hardly visible in the top view plans or models used to identify optimal installation positions 9 for electronic devices 10. In contrast to this, the inventive method can handle such situations since the simulations of monitoring and/or serving coverages 23 are carried out in a three-dimensional coordinate system 15. Again, in FIG. 8A only data points 19 that are part of the monitoring and/or serving coverage 23 are depicted.

FIG. 8C shows the determination of the monitoring and/or serving coverage 23 by means of ray tracing. The area 1 is thereby shown from a different perspective.

FIG. 9A and FIG. 9B show another embodiment of the invention. In the following, only the differences to FIG. 6A and FIG. 6B will be described. As can be seen in FIG. 9B, the shape of unrestricted monitoring and/or serving coverage 23 is also semi-spherically shaped. However, the area 1 in FIG. 9A differs from the area 1 in FIG. 6A. As can be seen in FIG. 9A, a water pipe 26 below the ceiling 7 crosses the area 1 and poses an obstacle for the monitoring and/or serving coverage 23 of the electronic device 10. In the prior art, this kind of area 1 is very difficult to handle because water pipes 26 are usually not visible in the top view plans or models used to identify optimal installation positions 9 for electronic devices 10. In contrast to this, the inventive method can handle such situations since the simulations of monitoring and/or serving coverages 23 are carried out in a three-dimensional coordinate system 15. Again, in FIG. 9A only data points 19 that are part of the monitoring and/or serving coverage 23 are depicted. FIG. 9C shows the determination of the monitoring and/or serving coverage 23 by means of ray tracing.

FIG. 10 shows a representation 3 of a flat in a top view. The flat has several rooms 8 which are interconnected via doors 27. In buildings 2 it is required to provide emergency paths 28 that lead outside the building 2. The emergency paths 28 can be described as graphs with several nodes 29 which are hierarchically sorted, as depicted on the right side of FIG. 10. Along an emergency path 28, it may be required to provide electronic devices 10 such as manual call points, exit signs or luminaires. Thereby, also the direction of the path 28 can be considered. Since the electronic devices 10 must be installed along the emergency path, the number of valid installation positions 22 can be drastically reduced, which saves computational time of the inventive method. Thus, the inventive method can be extended to comprise a step which defines a path 28 along which the electronic devices 10 shall be placed. The path 28 reduces the number of valid installation positions 22. Additionally, the direction of the path 28 can be included in the computation of the inventive method. In this way, the electronic devices 10 will be oriented correctly.

In another embodiment of the invention, it is possible to reduce the number of valid installation positions 22 on the basis of already defined, planned or even existing installation paths. FIG. 11 shows four different areas 1 in which optimal installation positions 9 for electronic devices 10 of a first type have already been defined. The optimal installation positions 9 for electronic devices 10 of a first type can be used to reduce the number of valid installation positions 22 for electronic devices of a second type. For example, only installation positions located on or in proximity to edges of a positioning grid 30 which nodes are defined by the optimal installation positions of the electronic devices 10 of the first type may be marked as valid. The edges of the positioning grid 30 are defined by connections between the optimal installation positions of the electronic devices 10 of the first type. Alternatively, valid installation positions 22 located on the positioning grid 30 may be weighted with a higher preference rank than installation positions located outside the positioning grid 30.

1. A computer implemented method for determining an optimal installation position of at least one electronic device in an area of a building, the at least one electronic device being configured to monitor and/or serve the area, wherein the method comprises the following steps:
i) Providing a representation of the building including the area, wherein the area comprises at least one building element comprising one or more of the following: a wall, a ceiling, a floor and a pillar;
ii) Generating data points arranged in a grid in a three-dimensional coordinate system, the data points representing the area with the at least one building element;
iii) Labelling each data point with a data point label, the data point label providing information if a respective data point is associated with the at least one building element and, if the data point is associated with the at least one building element, about which kind of building element the data point is associated with;
iv) Simulating placements of the at least one electronic device at valid installation positions within the area, thereby determining a weighted monitoring and/or serving coverage of the at least one electronic device for each simulated valid installation position, the monitoring and/or serving coverages covering data points with a certain data point label depending on a type of the at least one electronic device; and
v) Outputting the optimal installation position of the at least one electronic device with the highest monitoring and/or serving coverage.

2. The method according to claim 1, wherein the at least one electronic device is a sensor, comprising a fire detection sensor, a smoke detection sensor, a gas detection sensor or a presence detection sensor, an acoustic speaker, a camera, a luminaire, an antenna, a communication device or a wireless-device.

3. The method according to claim 1, wherein in step iv) the placements of the at least one electronic device are selected by an optimization algorithm, wherein the optimization algorithm takes into account the monitoring and/or serving coverages.

4. The method according to claim 3, wherein the optimization algorithm is a derivative-free optimization algorithm.

5. The method according to claim 1, wherein prior to step iv), the valid installation positions and/or the data points are weighted with a preference rank so that the monitoring and/or serving coverages are weighted.

6. The method according to claim 5, wherein the weighting of the data points is based on existing or planned installation paths and/or technical guidelines.

7. The method according to claim 1, wherein the valid installation positions depend on the type of the at least one electronic device.

8. The method according to claim 1, wherein invalid and valid installation positions are defined prior to step iv).

9. The method according to claim 1, wherein the cells of the grid have the form of a cuboid and/or the grid is regular.

10. The method according to claim 1, wherein prior to step ii) a bounding box is fitted to the area, wherein the bounding box serves as a basis for the grid.

11. The method according to claim 10, wherein the bounding box is aligned with the at least one building element of the area.

12. The method according to claim 10, wherein the bounding box and the area contained therein are moved to the origin of the three-dimensional coordinate system by a translation and/or aligned with the axes of the three-dimensional coordinate system by rotation.

13. The method according to claim 1, wherein the area is a room or a part of a room of the building.

14. The method according to claim 1, wherein the area is defined by a computational segmentation algorithm applied to the representation of the building.

15. The method according to claim 1,
wherein the method is applied to determining optimal installation positions of multiple electronic devices and wherein in step iv) placements of the multiple electronic devices at valid installation positions are simulated and wherein in step v) optimal installation positions for each of the multiple electronic devices are outputted; and
wherein in step iv) monitoring and/or serving coverages of the others of the multiple electronic devices are taken into account for each of the multiple electronic devices for determining the optimal installation positions.

16. A method for installing at least one electronic device in a building, comprising the following steps:
Determining an optimal installation position for the at least one electronic device by the method according to claim 1; and
Installing the at least one electronic device at the optimal installation position.

17. A data processing apparatus for carrying out the method according to claim 1.

18. A computer program product comprising instructions which, when the program is executed by a computer, cause the computer to carry out the method according to claim 1.

19. A computer-readable storage medium comprising instructions which, when executed by a computer, cause the computer to carry out the method according to claim 1.
